(19) United States
(12) Patent Application Publication
(10) Pub. No.: US 2015/0169802 A1
(43) Pub. Date: Jun. 18, 2015

(54) POLYMER FORMATION AND SIMULATION THEREOF

(71) Applicant: HOMELAND TECHNOLOGIES RESEARCH, LLC, Columbia, MO (US)

(72) Inventor: Galen J. Suppes, Columbia, MO (US)

(73) Assignee: HOMELAND TECHNOLOGIES RESEARCH, LLC, Columbia, MO (US)

(21) Appl. No.: 14/543,374

(22) Filed: Nov. 17, 2014

Related U.S. Application Data
(60) Provisional application No. 61/905,878, filed on Nov. 19, 2013.
(60) Provisional application No. 62/053,203, filed on Sep. 21, 2014.

(51) Int. Cl. G06F 17/50; B29C 67/00; G06F 17/13

(52) U.S. Cl. CPC G06F 17/5009; G06F 17/13; B29C 67/0088; B33Y 50/02

(57) ABSTRACT

A simulation method solves multiple differential equations to estimate concentration, degree of polymerization, and viscosity profiles for thermoset polymer forming reactions. For foam-forming reactions, the blowing agent evaporation to form foam cells is estimated. Critical and non-obvious advances to make these simulations useful include polymer-polymer reactions and the ability to simulate self (intra) reaction versus inter-reaction and mass transfer of blowing agent through resins as a function of degree of polymerization.

### CROSS REFERENCE TO RELATED APPLICATIONS

This application claims the benefit of provisional applications Ser. No. 61/905,878, filed Nov. 19, 2013, entitled “Convection Battery and Polymer Options” and Ser. No. 62/053,203, filed Sep. 21, 2014, entitled “Polymer Options”.

### FIELD

The present invention relates to a method using computer calculations to simulate and/or model the performance of a thermoset polymer formation reaction/process. Thermoset polymer formulations use monomers with an average functionality greater than 2.0 and usually greater than 2.5.

More-specifically, the present invention includes the following embodiments (a) a method of simulating polymer synthesis, (b) a method of characterizing the properties of polyol oligomers useful in the synthesis, and (c) a method of producing polyols with lower viscosity, (d) a method to simulate blowing agent performance during polymerization that forms foams, and (e) a method to simulation the degree of polymerization. The utility of the embodiments are not limited to the applications in the examples as provided.

### BACKGROUND

Simulation of thermoset polymer formation includes the simultaneous solution of multiple differential equations that describe chemical reaction, energy balance, mass balance, and physical processes. This invention is on advanced aspects of this simulation including simulation of how blowing agents create foams and how the simulated performance used in combination with measured profiles, such as changes in temperature and viscosity, can be used to characterize the monomer.

### SUMMARY

A process for simulating the polymer-forming (or oligomer-forming) reactions is useful for expediting development of new formulations including the following: (a) incorporating alternative monomers/oligomers, (b) incorporating alternative catalysts, (c) incorporating alternative blowing agents, (d) identifying combinations of temperature control and length of reaction to achieve desired performance, and/or (e) identifying additives to achieve desired performance.

A key aspect of the simulation is distinguishing reactions between moieties on polymers as either intra-polymer (also referred to as “self”) or intra-polymer reaction. In the absence of accounting for polymer-polymer self-reaction; a simulation code can readily predict negative concentrations, which is not realistic. Likewise, polymer-polymer self-reaction will slow down the rate of increase in degree of polymerization, and for some applications that slowed-down rate is more representative of the real process. When describing embodiments “intra” and “self” are used interchangeably. Also, “moiety” and “group” are used interchangeably when referring to structures on chemical molecules.

### BRIEF DESCRIPTION OF THE DRAWINGS

FIG. 1. Simulation profiles illustrating the of impact of 100% inter (n=0), 100% intra (n=−0.3334) and side reaction on polymerization reactions (a), Comparison of actual performance of the model and −[constant]*DP̂⅓ modification (b).

FIG. 2. Simulation profiles and comparison to experimental data for urethane foams from several blowing agents.

FIG. 3. Example block flow diagram showing calculation blocks including simulation of blowing agent performance.

### DETAILED DESCRIPTION

### Programming Method to Simulate Polymer Synthesis

The basic embodiment of this invention is a process for simulating an oligomerization or polymerization reaction comprised of four or more of the following:
1) Arrhenius-type constants characterization of reactivates of chemical moieties that may include variations depending upon generally where the moiety is attached to the molecule,
2) Group contribution parameters and calculation algorithm for estimating viscosity of molecules based on the structure and size of the molecule including estimating the impact of temperature on viscosity.
3) Group contribution parameters and calculation algorithm for estimating heat capacities of molecules based on the structure and size of the molecule.
4) Data on a limited but useful set of molecules including such things as the general structure of the molecule and number of reactive moieties where the data is sufficient to calculate reactivities, viscosities, and heat capacities.
5) Data characterizing catalysts including reactivity (and optional propensity to become deactivated) including Arrhenius-type constants characterization of reactivates as specific to catalysts and moieties.
6) A calculation algorithm that includes the following for the purpose of estimating reactive moiety concentration, degree of polymerization, temperature, and viscosity as a function of time:
7) Mixture rules that combine component viscosities and component heat capacities to estimate mixture viscosity and mixture temperature.
8) The solution of more than five differential equations describing changes in composition that occur as a result of reaction.
9) Calculation of gas phase nucleation, gas evolution, impact of gas evolution (e.g., latent heat) on temperature, gas bubble growth, surfactant stabilization of bubbles, bubble rupture, and standard approaches to control reaction such as addition of glycerol.
10) In corporation of a correlation (e.g., an equation) that characterizes the extent to which a large molecule with multiple reactive moieties will react with itself versus reacting with another larger molecule whereby that correlation approaches (or is equal to) 100% self-reaction as the molecule become very large where that correlation approaches (or is equal to) 0% self-reaction when the degree of polymerization is zero.
11) Estimation of the extent of evaporation of blowing agents (soluble in monomer mixture before reaction) including one or more of the following options: a) calculation of pure component blowing agent vapor pressure as a function of temperature, (b) at least one equation accounting for non-idealities of vapor pressure including the use of an activity coefficient for the blowing agent, (c) at least one equation accounting for driving forces of mass transfer from the liquid to the vapor phase based on a mass transfer coefficient, and (d) a model accounting of how one or more mass transfer coefficients are functions of the degree of polymerization where increasing degrees of polymerization lead to decreasing mass transfer coefficients.

More concisely stated, the preferred basic simulation method for simulating a polymerization reaction is comprised of at least: a calculation algorithm that includes estimating reactive moiety concentration, degree of polymerization, and temperature as a function of time; solution of multiple differential equations describing changes in composition that occur as a result of reaction; data on monomers including the number of reactive moieties on the monomers, the concentration of reaction moieties of the monomers, reaction rate parameters sufficient to calculate reaction rate constants, heats of reaction, and heat capacities; data characterizing the impact of catalysts on reactivity as a function of temperature, catalyst, and type of reaction; and the reaction of a polymer molecule with itself in a self-reaction resulting in no change in polymer concentration and the reaction of a polymer molecule with another polymer molecule resulting in a decrease in polymer concentration including a calculation algorithm with two limits of reaction such that at the limit of monomer extent of reaction of zero there is 0% polymer self-reaction, and at the limit as polymer concentration (e.g., moles/liter) goes to zero due to self-reaction after reaching a peak polymer concentration there is 100% polymer self-reaction.

The limit of monomer extent of reaction of zero of 0% polymer self-reaction requires modification for systems having highly functional monomers. For example, for a reaction system with A-monomers and B-monomers where all monomers are two-functional, there is zero inter-polymerization in the limit of extent of reaction of zero. However, as soon as one A monomer reacts with one B monomer where at least one is highly functional, there is a tendency to self-react (intra-polymerize) that increases with increasing degree of polymerization and increasing functionality of the monomers. An extrapolation of this tendency to extent of reaction of zero leads to a fraction of intra-polymerization that is greater than zero in the mathematical representation. Quantifying the amount of intra-polymerization in the limit of zero extent of reaction can be specific to catalysts.

The term algorithm refers to a series of rules that are applied in a logical manner. For purposes of programming, the algorithm can be an equations that exhibits desired limits in performance. Often times such an equation is fundamentally related to a more complex algorithm the takes into account all factors but is much easier to use. Often times such an equation may be inaccurate in regions where the inaccuracy has little impact on the overall simulation, and so, the equation provides reasonable results.

In the more preferred application of the basic simulation method, the simulation reagents are comprised of an A-side monomer mixture and a B-side monomer mixture where at least one of these mixtures is characterized as fractions of moieties having different reaction rates. More preferably and in the case of simulating the formation of polyurethane polymer, the B-side monomer is a polyol mixture and the fractions include at least the fraction primary alcohol and the fraction secondary alcohol.

More specifically, the algorithm includes the calculation of average degree of polymerization and use of the average degree of polymerization to estimate the rate of self-reaction.

In one embodiment, there is a function of the type where c1*(DP)/(1+c1*(DP)) or of type [c1*(DP)+c2*(DP)̂2]/(1+c1*(DP)+c2*(DP)̂2). Whereby DP is related to other properties (e.g. MW), this function would be used to estimate key properties during simulation. The use of this simulation for developing new formations based on use of a catalyst (or monomer or surfactant or fire retardant or additive) used in quantities not previously used in that formulation. The process is particularly useful for simulating and utilizing natural molecules in oligomers and polymers such as natural oils like soybean oil.

The more-preferred embodiment the algorithm for estimating the amount of polymer-polymer reaction that is self-reaction is fundamentally based. Here, the ratio of inter versus intra polymerization is a function of the degree of polymerization (DP). The stoichiometric coefficient for the polymer-forming reactions are expressed as a function of DP, namely −DP̂n. At the beginning of the reaction—where all reactions are intermolecular—the stoichiometric coefficient (−DP̂n) is −1 as DP is 1. As the reaction proceeds, more intramolecular reactions take place and also DP gets larger and increases to infinity, leading to the stoichiometry coefficient to be reduced to −1/∞ or 0.

The value of the parameter n would theoretically vary from 0 (all intermolecular polymerization,) to −⅓ (maximum intramolecular polymerization,). When n=0, −DP̂n is equal to −1 for all DP, which corresponds to Flory's assumption of zero intrapolymerization.

A value of n=⅓ as the lower limit of interpolymerization is based on a model using the following three assumptions: (a) the polymer molecule is assumed to have the geometry of interconnected strings of diameter d and cumulative length L with surface area πdL and volume π(d/2)²L, (b) when the string is coiled into a sphere it will have the greatest tendency for intra-molecular reaction where the sphere has a radius of [¾L(d/2)²L]^{1/3} which is derived by noting that the volume of the sphere is the same as the volume of the coiled string, and (c) when coiled into the sphere the fraction of reactions that are inter-molecular is equal to the surface area of the sphere divided by the surface area of the string. The length of the string and d is the diameter of its cross sectional area. L is proportional to DP and all terms except DP are presented as a constant time DP̂(−⅓). In the broader sense, this equation becomes m*DP̂n which yields the fraction of polymer-polymer inter-polymer reactions that leads to a decrease in polymer concentration.

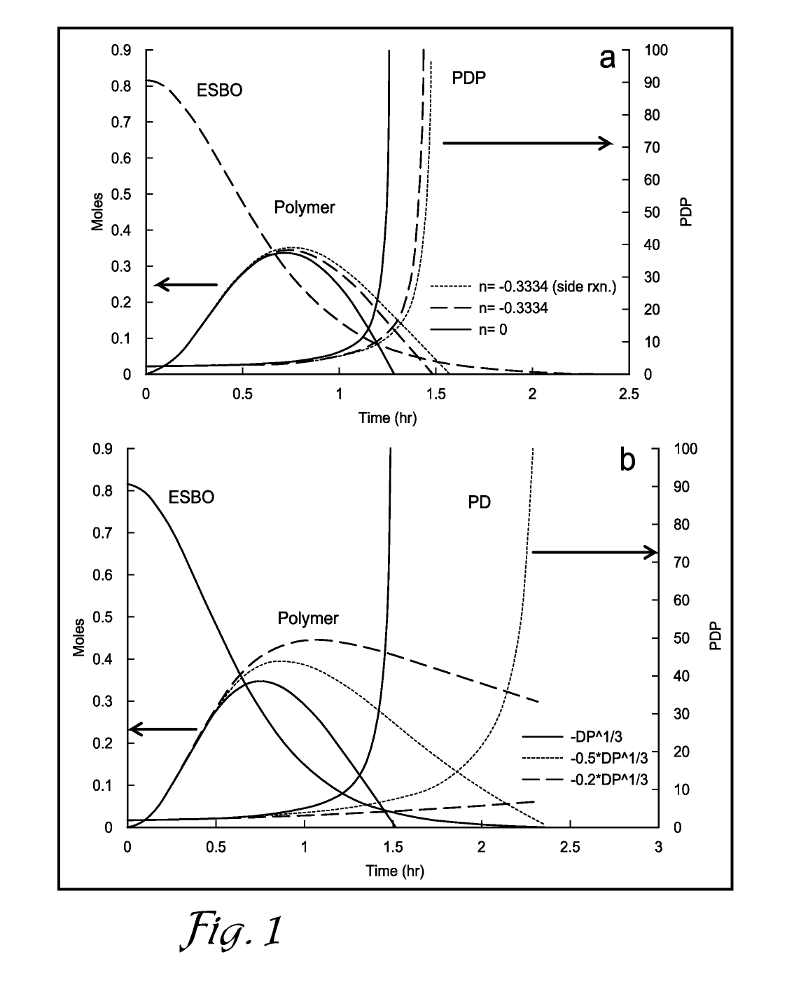

The equation m*DP̂n is an example of the algorithm, where, in the limit as polymer concentration goes to zero (DP becomes large) this factor (for inter-polymerization) goes to zero where the fraction of intra-polymerization (1−m*DP̂n) approaches 1.0. Further details on the use of this particular algorithm (in this case, an equation) are summarized in Illustrative Example 1 and FIG. 1. The constant “m” is the limit of this model as DP goes to 1.0. In the most preferred embodiments monomer functionalities are used to estimate m. The constant n is influenced by the configuration of the polymer (between limits of linear and spherical) which depends on temperature, the difference of solubility parameters of the monomers, and the functionality.

The minimum interpolymerization occurs when the molecule is wound into the geometry of a sphere which is the geometry with the minimum surface area c volume ratio. This equation must be valid in the limit of performance of low DP. For step growth polymerization of A-Side and B-side monomers each having a functionality of 2, the limit presents the value that interpoiymerization=1 at DP=1, and so the constant is equal to 1. For functionalities greater than 2 and for cases where the functionality is not lost in reaction e.g., alcohol reacting with an epoxy), the constant can be less than one indicating that the equivalent of DP=1 may has some potential for intrapolymerizatio (self-polymerization). The limit should be correct; however, it need not represent actual performance at DP=1 since this equation is only applied to molecules of DP greater than or equal to 2. This constant having values less than or equal to one, is primarily a function of the average functionality of the monomers and may be used as a fitted parameter or it may be derived based on theory. Illustrative Example 1 at the end of this section describes an example of an oligomerization reaction to form a polyol. Illustrative Example 2 expands upon Illustrative Example 1 to include a sensitivity analysis of the modeling of that reaction using different values of n for the stoichiometric coefficient −DP̂n which is used to define the fraction of polymer-polymer inter-reactions that lead to crosslinking (decrease in polymer concentration).

### Chain Catalyst Growth Algorithm

An inspection of by example, the urethane-forming reaction suggests that this reaction is a step growth polymerization. However, if a homogenous catalyst used and polymer growth includes a mechanism of the catalyst forming a complex with an alcohol or an isocyanate, a chain-growth mechanism can dominate the kinetics. The basic simulation method can be modified to simulate chain growth polymerization, this modification is comprised of a chain growth reaction algorithm that includes the concentration of a complex of a catalyst with a reactive moiety in at least one reaction rate expression. The reaction rate expressions for chain growth polymerization would include the rate of association to form the complex as a rate constant times a catalyst concentration times the concentration of a moiety and the rate of disassociation as a rate constant times complex concentration to characterizing the rate of catalyst disassociation. In general, the rate of polymer propagation reactions to the rate of disassociation is related to the kinetic chain length which is a chain length free of crosslinking.

The preferred method for simulating catalyst chain growth polymerization is comprised of at least one rate expression for the formation of the complex, at least one rate expression for the disassociation of the complex, and an algorithm that estimates the initial concentration of the complex as an initial condition.

### Mass Transfer Resistance

For polymer reaction systems, reaction rates can be mass transfer limited if the kinetic rates are very high due to, for example, high catalyst loadings with primary functional groups. As polymer networks are formed and viscosities increase, both reaction rates and transport of blowing agents through the resin phase can be mass transfer limited.

The basic simulation method can be improved to include mass transfer limits at conditions of fast reaction rates; this improvement is comprised of at least one differential equation for estimating the rate of mass transfer of a first moiety to a second moiety where the first moiety and second moiety react to form a polymer bond. In this improvement, the smaller molecule is the one that would be modeled as undergoing mass transfer and either reactive moiety may be on that this smaller molecule. The differential equations for mass transfer are first order in the concentration of one of the moieties, where the differential equation is a rate with respect to time, where the equation includes a moiety mass transfer factor multiplied times a concentration driving force for the rate, and where the moiety mass transfer factor is estimate by an algorithm where the algorithm estimates the moiety mass transfer factor to increase with increasing temperature and to decrease with increasing average degree of polymerization of the polymer.

At a constant concentration profile, increasing temperature leads to increasing mass transfer rates. At a constant temperature, increasing degrees of polymerization will generally lead to decreasing mass transfer rates. Mass transfer rates decrease rapidly as the polymer concentration goes o zero at the gel point.

During polymer forming reaction simulation, polymer concentrations will initially increase. After reaching a maximum concentration they will decrease due to crosslinking for a thermoset system. The polymer concentration approaches zero, often times very rapidly, at the gel point.

### Predicting Emissions to Surrounding Air

Simulation of resin-forming reactions can be extended to simulate emissions to the air in contact with the resin (or foam) being formed by the reaction. To simulate emissions to surrounding air, the basic simulation method includes a first algorithm for estimating of vapor phase emissions in the air surrounding the foam where the algorithm is comprised of estimating the partial pressures of chemical components of the resin phase where the vapor pressures of components increase with increasing pure component vapor pressures. Part of the algorithm is an equation comprised of a pure component vapor pressure times the concentration times an activity coefficient. This can be applied to resin phase concentrations of blowing agents, monomers, catalyst, and other components that have vapor pressures greater than about 0.001 bars. Furthermore, the activity coefficient is perferably a function of degree of polymerization (DP) where increasing DP increases vapor pressure. The algorithm may include a mass transfer factor times a driving force for evaporation to form the partial pressure where the driving force for evaporation is a function of pure component vapor pressure and where the mass transfer factor exhibits a tendency to decreases with increasing DP and a tendency to increase with increasing T in a manner that us. This approach accounts for the outer surface of a resin or foam.

For a foam, open cells can lead to significant contributions to air emissions from locations other than on the surface of the foam. An improved method for simulating emissions to surround air includes a second algorithm for estimating the fraction of open cell content in the foam and the fraction of closed cell content where the sum of two fractions is 1.0 and where the first algorithm includes the use of a mass transfer factor and where a third algorithm estimates the mass transfer factor where increasing open cell content causes the mass transfer factor to have a tendency to increase. Here, the reference to having a tendency to increase refers to the mass transfer factor increasing if all other factors are constant; however, the ultimate increase or decrease in the mass transfer factor may depend on many factors having different impacts. More preferably, the second algorithm includes the calculation of viscosity and the amount of blowing agent that has evaporated to determine the fraction of cells that rupture leading to open cell formation.

When specifically simulating emissions of isocyanates or resin phase concentration of isocynates, reaction with water is preferably included in the simulation such that the concentration of water does not go below a threshold value as related to the humidity of air surrounding the foam. The simulation method to simulate this includes use of rate equation for the reaction of isocyanate with water where the concentration of water in the resin reacts to a value other than zero by accounting for mass transfer of water from air humidity into curing resin. force per area generated by the foam opposite a compression force. Closed cells are able to register an increase in pressure when compressed as a gas phase contribution to the stress against compression.

### Estimating Physical Properties of Foams

When applied to urethane foams, the basic simulation method preferably include simulation of foam properties of interest to customers. These properties include but are not limited to thermal conductivity, compressive strength, and relations between stress and strain. The preferred method for simulating these physical properties starts with differential equations on the rate of energy accumulation as derived from an energy balance which includes: heat effects associated with generation of blowing agent gas, estimation of final volume of gas cells in the resin, estimation of physical properties of the foam as the addition of the gas phase contribution to the physical property plus the resin phase contribution to the physical property.

For stress-strain estimates of foams containing closes cells, the stress against compression is the force per area generated by the foam opposite a compression force. Closed cells are able to register an increase in pressure when compressed as a gas phase contribution to the stress against compression.

### Method of Characterizing the Properties of Polyol Oligomers

In the polyol industry where billions of pounds per year of polyols are used to synthesize urethanes, several analytical methods are used to characterize the polyols. When combined with statistical process control the characterization is thorough; however, for new polyols these standard methods are not sufficient for characterizing such things as molecular weight. When combined with reaction simulation, it is possible to perform a thorough characterization with less wet chemistry. This embodiment is on the use of a single wet-chemistry method used in combination with reaction simulation to characterize an oligomer such as a polyol. For polyols this embodiment is able to characterize concentration of functional groups (hydroxyl number), relative reactivity of functional groups, and the number of functional groups on a molecule.

This embodiment is an analytical process evaluating a monomer for copolymer (a polymer formed by two monomers that react with each other) application consisting of following steps: 1) measuring the mass and/or volume of a sample, 2) mixing the sample with an appropriate amount of its counter-monomer and optional catalyst or other components WITH measurement of temperature and viscosity as a function of time, and 3) collection of data and analysis by computer program that will back-calculate the concentration of functional group based on the temperature profile and the average functionality based on viscosity as a function of time.

Further definition of the process includes a process where the characterization is based on viscosity versus time performance in a gel formulation. The information form viscosity profiles may be augmented by temperature versus time performance in a gel formulation. The process where the simulation is based on solving differential equations based on solving temperature-dependent reaction kinetic parameters.

The embodiment can be applied, in general, to thermoset polymers. The method of this embodiment is particularly useful for adopting renewable prepolymers into thermoset formulations.

Concisely stated, a method for using polymer-forming reaction simulation to estimate the physical properties of monomer includes a comparison of viscosity versus time and temperature versus time of a gel reaction where at least one property of at least one of the monomer is a fitted parameter that is varied to obtain a best fit of that parameter to characterize the monomer. This is particularly useful where the monomer property is the functionality of a polyol that is obtained by weighting the parameter fitting method to data on viscosity near time when the viscosity rapidly increases to the upper values that were experimentally measured.

### Predicting Successful Foam Formation

The polymer-forming simulation method can include the calculation of viscosity as well as formation of gas (or vapor) cells within resin walls. A comparison of viscosity to cell growth profiles can be used to predict successful foam formation where success is an absence of collapse of the foam. More successful foam formation is consistent with more efficient use of blowing agent. The preferred method for predicting the successful formation of a foam is a method where the differential equations include an energy accumulation rate equation as derived from an energy balance which includes: heat effects associated with generation of blowing agent gas, estimation of final volume of gas cells in the resin, estimation of viscosity of the resin phase, and an algorithm to determine whether the fraction of blowing agent that escapes to surrounding air, remains in the resin, or successfully forms cells of a foam. Preferably, the algorithm is able to estimate the extent to which a foam will collapse after cell formation based on consideration of constraints on minimum viscosity and cell wall stress to support the weight of the foam above the lower portions of the foam.

### Method of Producing Polyols with Lower Viscosity

This embodiment is a method for reducing the viscosity of a soy-based polyol consists of capping a soy-based polyol with diethylene glycol, triethylene glyol, or other linear glyol with more than two three repeat ether units. Lower viscosity polyols mix and react better, including improved wetting and coating characteristics.

Soy-based polyols can be synthesized by first epoxidizing soybean oil and then oligomerizing the ESBO with ethylene glycol. A problem with this approach is that the best-performing of a series of these products have viscosities between 10,000 and 30,000 at ambient temperature. It is desirable to produce a produce with similar molecular weight but lower viscosity.

This embodiment uses a capping reaction of di, tri, or higher glycols referred to as di-plus glycols. The process of this embodiment is an alcohol addition of glycol to an epoxide of a vegetable oil consisting of a first reaction step where at least 10% of the epoxide is reacted with a reagent other than a di-plus glycol followed by a second reaction step where a di-plus glyco is added and reacted. This results in a produce of reduced viscosity at the same extent of reaction. Illustrative Example 1 is provided at the end of this section.

### Blowing Agent Simulation

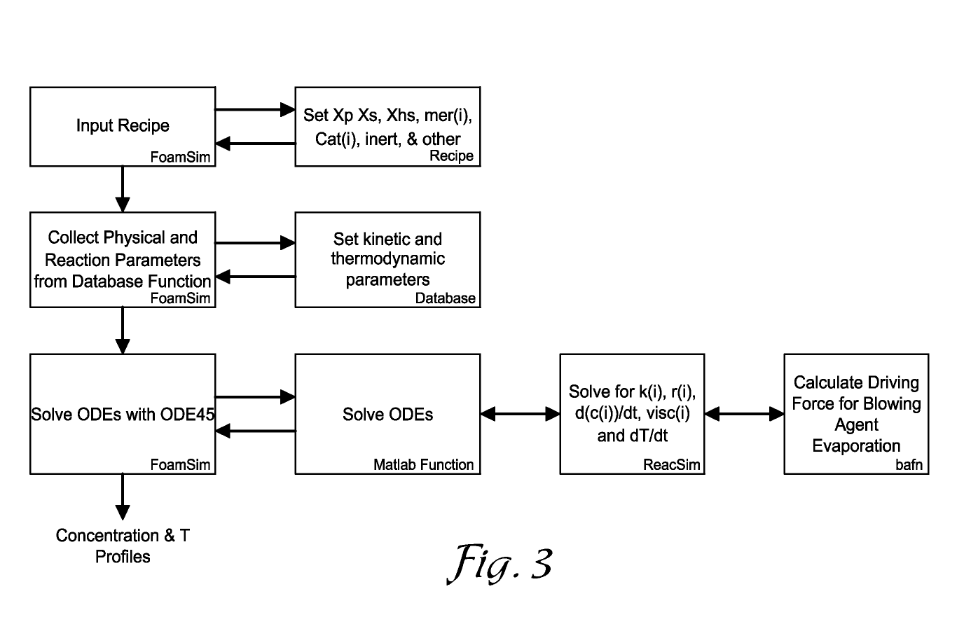

Proper simulation of the evaporation of blowing agents is important during the simulation of a polymer foam such as polyurethane foam because it impacts temperatures (heat of vaporization) and because the timing of gas generation must be coordinated with other factors (e.g., viscosity) for the successful generation of cells. The (proposed) invention is on a method to simulate the evaporation of physical blowing agents. A physical blowing agent is one that evaporates during the foaming process as a result of temperature increases from the heat of reaction. FIG. 3 illustrates one embodiment for including blowing agent simulation with the simulation of reaction and temperature profiles.

Proper simulation of the evaporation of blowing agents is important during the simulation of a polymer foam such as polyurethane foam because it impacts temperatures (heat of vaporization) and because the timing of gas generation must be coordinated with other factors (e.g., viscosity) for the successful generation of cells. The (proposed) invention is on a method to simulate the evaporation of physical blowing agents. A physical blowing agent is one that evaporates during the foaming process as a result of temperature increases from the heat of reaction.

A summary key aspects of this embodiment includes the following: 1) A method for simulating the evaporation of one or more blowing agents during the simulation of an exothermic polymer-forming reaction comprised of estimating the rate of evaporation of evaporation as a constant times a driving force for evaporation. 2) The driving force for evaporation is the difference between a quantity based on gas phase properties and a quantity based on liquid phase properties. 3) Liquid phase property is related to the concentration of blowing agent in the liquid phase and the gas phase property is related to the concentration of the blowing agent in the gas phase. 4) The liquid phase property is the mole fraction of blowing agent in the liquid phase multiplied times an activity coefficient and the gas phase property is the mole fraction of blowing agent in the gas phase divided by the vapor pressure of the pure blowing agent at that temperature. 5) The concentration of polymer is estimated during reaction and is included in the calculation of the calculation of the mole fraction of blowing agent in the liquid phase. 6) The rate of change of blowing agent in the liquid phase is used to estimate the heat needed to evaporate the blowing agent from the liquid.

An improved algorithm includes the ability of the algorithm to predict that some of a physical blowing agent can (and will) be entrapped in the resin phase (as opposed to gas cells in foam or escape from the foam). The improvement where the “constant times a driving force” method for estimating the mass transfer of a blowing agent uses a “Dependent Variable” rather than a “constant” whereby the Dependent Variable depends on (is a function of) degree of polymerization (either directly or indirectly dependent). An example form of this functon is K/DP̂n or K/PDP̂n where K is a constant, DP is degree of polymerization, PDP is monomer-free degree of polymerization, and n is real number typically between 02 and 5 (more commonly between 0.5 and 3). In the simulation, PDP is calculated at the moles of monomer that have reacted divided by the moles of polymer present on a common basis such as one liter of reaction mixture resin.

Mathematically, it is easier to work with K′*[polymer concentration] where K′ is a different constant than K and where this equation is only valid after a peak polymer concentration is reached. The fact that it is not valid for the blowing agent at the onset of the polymerization reaction can have little impact since the blowing agent will tend not to evaporate until fractional conversions of polymers greater than at least 0.05. Illustrative Example 3 shows simulation results for several blowing agents using this model.

Furthermore, the more-preferred form of the “constant times a driving force” function is one of many commonly used forms used characterize mass transfer where the “area” term of the common mass transfer coefficient terms is either assume to be constant (which it is not) or is assumed to be a function (direct or indirect) of the amount of blowing agent in the gas phase.

Concisely stated, the method for predicting foam formulation is comprised of simulating the evaporation of one or more blowing agent during the simulation of an exothermic polymer-forming reaction comprised of estimating the rate of evaporation of evaporation as a blowing agent mass transfer factor times a driving force for evaporation. This factor is not necessarily the same as that used for the rate expression on the mass transfer of a moiety. The driving force for evaporation is the difference between a quantity based on at least one gas phase property and a quantity based on at least one liquid phase property where the liquid phase property is related to the concentration of blowing agent in the liquid phase and the gas phase property is related to the concentration of the blowing agent in the gas phase. Preferably, the liquid phase property is the mole fraction of blowing agent in the liquid phase multiplied times an activity coefficient and the gas phase property is the mole fraction of blowing agent in the gas phase divided by the vapor pressure of the pure blowing agent at that temperature. Preferably, the concentration of polymer is estimated during reaction and is included in the calculation of the estimate of the mole fraction of blowing agent in the liquid phase.

Evaporation of blowing agent will impact temperature profiles relative to the gel reactions. The preferred method thus uses the rate of change of blowing agent in the liquid phase in an energy balance equation to estimate changes in temperature during the simulation. Preferably, a calculation algorithm estimates the blowing agent mass transfer factor where the blowing agent mass transfer factor has a limit of performance such that as polymer concentration (e.g., moles/liter) goes to zero due to self-reaction the factor is less than 0.2 times the value of the factor at peak polymer concentration. More preferably, the algorithm includes the use of a dependent variable that directly or indirectly dependent depends on degree of polymerization. An example form of this function is K/DP̂n or K/PDP̂n where K is a blowing agent mass transfer factor, DP is degree of polymerization, PDP is monomer-free degree of polymerization, and n is real number typically between 02 and 5 (more commonly between 0.5 and 3). Furthermore, themore-preferred form of the “blowing agent mass transfer factor times a driving force” function is one of many commonly used forms used characterize mass transfer where the “area” term of the common mass transfer coefficient terms is either assume to be blowing agent mass transfer actor (which it is not) or is assumed to be a function (direct or indirect) of the amount of blowing agent in the gas phase. Most preferably, the simulation of blowing agent includes an end of the expansion at high degrees of polymerization; more specifically, the expansion of the foam formed by gas formation in a resin ends within 30 seconds after the degree of polymerization exceed 10,000 and blowing agent that has not evaporate is entrapped in the resin phase.

In the algorithm (in this case an equation) K/PDP̂n the value of PDP can be calculated as [moles of monomer reacted per liter]/[moles per liter of polymer]. In the application f this calculation of PDP it is often necessary to include methods in the programming code to make prevent calculational anomalies (e.g., imaginary numbers) when concentrations approach zero. The key aspect of this equation is that as the concentration of polymer goes to zero after reaching a peak value, this equation predicts the mass transfer coefficient to approach zero. Temperature will increase mass transfer coefficients, and in the case of K/PDP̂n, increases in temperature lead to increases in K when other factors are held constant. These types of heuristics that provide increasingly accurate modeling capabilities are what ultimately rise an equation to the level of being an algorithm.

Use of expandable (foam-forming) polymers in 3D printing has the following advantages: 1) Expedited time and increased productivity by use of lower-resolution printing at designated volumes, and 2) Higher performance parts by avoiding over-design of section that can be made of lower density (foam-like) materials such as interior sections of rods.

The basic embodiment optionally includes computer-based simulation to estimate foam properties. Here, a three-dimensional printing method comprised of an application method where an A-side monomer mixes with a B-side monomer to form a three-dimensional thermoset polymer product comprised of: at least two application resin mixtures where at least one of the resin mixtures generates a gas as a result of mixing, and a computer-based calculation method in provide mixing ratios of the resin mixtures to achieve a desired foam density.

An expedited application method is realized where the computer-based calculation method controls the printer to print at a higher surface rate of coverage when applying foams of lower density.

A 3D printing method may include the step of printing a surface followed by filling the surface with an expanding polymeric material, whereby the expansion is caused by formation of vapor/gas cells within the polymer causing an outward pressure which causes the overall density of the polymer/cell system to decrease by expanding upward and expanding outward to the containing surface, whereby the printing of the lower density (expanded) section is performed at a lower printing resolution that translates to a faster printing process.

The preferred properties of the foam are as follows: Rigid or flexible foams have qualities making them suitable for different applications. For an object that is designed to have less than 10% compression at a force of 20 psia, a rigid foam is preferred. The “depth” dimension of the foam is that dimension perpendicular to the surface in which the foam expands. A “formable depth” is defined as that distance perpendicular to the surface with a “tapping” action is applied to form the foam.

The formable depth is typically 2% to 20% of the depth. The open cell content of a foam is preferably greater than 10% in the printable depth, more preferably greater than 20%, and most preferably between 30 and 60%.

Tapping by contact is most preferred after the tack-free time of the polymer is reached. Unfortunately, the polymer is most formabhe prior to the tack free time. The preferred embodiment includes placing a material over the foam that has a quick tack-free time. The preferred material for this is a polymer similar to that of the foam, but which has a lower tack-free time. One method of attaining a lower tack-free time is to put more catalyst in the layer polymer. The preferred tack-free time for the bulk foam is 10 to 1000 seconds and more preferably between 100 and 500 seconds. The preferred tack-free time of the layer is 0-200 seconds and more-preferably between 10 and 100 seconds.

Alternative to printing the low-tack-free time layer on the foam, the layer is sprayed on. This layer may be a polymer, a powder, a film, amid/or a liquid. For increased compressive strength and/or decreased thermal conductivity it is preferred to layer the foam such that the foam at greater than 20% of the depth has an open cell content less than 20% while the foam in the formable depth has an open cell content as previously described.

Concisely stated, this tapping-based method is comprised of comprised of the following steps, printing of a wall having a density is greater than 0.5 g/ml, printing of a foam next to the wall having a density less than 0.5 g/ml. where the upper surface of the foam is tapped to provide the desired contour.

The surface of the foam after expansion may be scanned and optionally mapped (on small or large scale). Voids in the surface are preferably filled with printing of foam whereby the density of the foam formulation increases as the size of the void decreases. Concisely stated, this method first scans the surface and printing is performed to fill in crevices of the surface.

A 3D printing on the top of a polymer foam surface consisting of, timing of the printing on the surface such that the printing occurs at a viscosity greater than 20,000 cP but less than 1E10 cP, where by the printing on the surface occurs after the tack-free time of the surface but before the surface is fully set, whereby the printing occurs such that the printed surface on the foam surface forms an adhering bond, whereby the printing is preformed to provide a finished surface quality or surface ready for non-reactive finishing methods.

Optionally, said foam surface printing consists of first of detecting the location of the surface followed by the controlled printing at the detected location. Optionally, whereby prior to the printing on the surface but after the tack free time, a “tapper” nudges and molds the surface by tapping on the surface or by short bursts of air on the surface to mold and/or flatten surface prior to printing. Printing applying an expanding (by gas/vapor cells) polymer by program-specified whereby the density of the polymer can be pre-determined by addition of blowing agent. One blowing agent embodiment uses water as a blowing agent whereby water reacts with a foam component to form a gas such as carbon dioxide (e.g., by methods known in urethane chemistry).

An alternative blowing agent embodiment uses a physical blowing agent whereby the conditions at the “curing” surface are maintained at a temperature higher than the applicator/printer whereby the higher temperature and/or heat of reaction leads to evaporation of the blowing agent.

A 3D printing material that is formed by the mixing of an A-side monomer and a B-side monomer. in one embodiment, the A and B sides are mixed in the printer tip in the application process. Alternatively, the A and B sides are applied separately by different applicators either in sufficiently fine resolution to mix and react or simultaneously so the mix and react on contact. Concisely stated, a first printer tip applies a mixture containing the A-side monomer and a second printer tip applies a B-side monomer where the first and second printer tips apply different monomers within 0.3 mm distance of separation.

Blowing agent may be applied in a third applicator or on mixing with either the A-side or B-side. The embodiments of this include use of solids forming composites. Carbon fiber is an example of such a fiber.

3-D printing by robots is a means of house construction. Such construction includes house-wall construction including the printing of the surface of the wall with a high-density material and the printing (or otherwise filling) of foam material between two surfaces. For this application, the resin mixtures are applied by a mobile applicator able to traverse an independent surface of greater than one square meter.

The embodiments of this (potential) invention may be applied to lathe systems where a core stock of inexpensive material (e.g., foam rod, wood rod) built upon by applying polymers forming thermosets including foam-forming polymers. Here, the preferred approach to mold would not be tapping, but rather, application of on the rotating lathe such as air pressure or a rolling wheel. Here, the resins are printed on a surface and the surface is a series of circumference surfaces on a rotating lathe.

### 3-D Printing with Wire Feed

The 3-D printing is not limited to dot printing. Wire printing may also be applied where a wire of pre-polymer (or monomer) is applied and melted at the surface of application. A preferred embodiment includes the application a wire consisting of an inner wire, an outer shell, and a separating layer between the core and shell. A most-preferred embodiment comprises an outer shell and an inner core where one (core or shell) has an index greater than 100 (100 corresponding to stoichiametric amounts of reactive moieties, greater than 100 indicates more isocyanate moiety is present than alcohol) and the other an index less than 100 whereby the core and shell materials have thermoplastic properties when separate due to the index value, but when combined they react to form a thermoset.

The cores, shell, and layer, have a melting points above the temperature where the wires are kept prior to application and below the temperature of application. The layer may be any of a number of materials that is non-reactive but soluble with the urethane. Preferably, the material (core or shell) with the lower index (more polyol than isocyanate) will have polyols with functionality greater than 2.0 and preferably greater than 2.2.

One embodiment includes the use of a second wire that may be applied simultaneous to the first wire where the second wire has a water content such that it initiates blowing when applied reacted with the contents of the first wire. In a method for applying the A-side and B-side, a software calculation operating in conjunction with the printing hardware, whereby, the simulation software estimates density and open cell content to provide application of materials consistent with desired performance.

In the preferred wire feed embodiment, the resin mixtures are in the form of resin wires where at least one of the wires is a thermoplastic resin wire comprised of a mixture of thermoplastic resin mixed with a monomer where the monomer has a functionality greater than 2.0. More preferably, the thermoplastic resin wire contains a monomer having a functionality greater than 2.2. The one thermoplastic resin wire is preferably comprised of a B-side polyol monomer mixed with a thermoplastic having unreacted alcohol moieties, and water. Blowing agent can also be put in the thermoplastic resin where the thermoplastic resin wire contains a physical blowing agent which evaporates when temperatures exceed 35 C.

In the most-preferred embodiment, at least one of the thermoplastic wires is comprised of a core and a shell where both the core and the shell contain monomers and where the monomers of the core react with the monomers of the shell.

The thermoplastic nature of the wires allows the wires to melt, mix, react, and ultimately set in the 3-D printing. Methods are known in the science make mixtures with thermoplastics that melt at temperatures specific to 3D printers.

### ILLUSTRATIVE EXAMPLE 1

A series of polyols were synthesized by reacting fully epoxidized soybean oil (ESBO) with different combination of ethylene glycol (EG), diethylene glycol (DEG), and triethylene glycol (TEG). p-Toluenesulfonic acid monohydrate was used as a catalyst. Table 1 summarizes the recipes used for the five batches synthesized in this study. The different products are referred to as EE, ED, ET, EED and EET as defined in Table 1. The EE, ED and ET polyols contained 9.5 wt % alcohol while EED and EET polyols contain 6 wt % EG. The total number of moles of alcohol was kept constant for all recipes. All mixtures contained 0.5 wt % catalyst.

TABLE 1
Chemical recipe for polyols.

| Batch | Polyol | ESBO (g) | EG (g) | DEG (g) | TEG (g) | Catalyst (g) |
|---|---|---|---|---|---|---|
| 1 | EE | 815.5 | 84.5 | 0 | 0 | 5 |
| 2 | ED | 753.9 | 0 | 146.9 | 0 | 5 |
| 3 | ET | 632.6 | 0 | 0 | 268.6 | 5 |
| 4 | EED | 792.2 | 54 | 53.8 | 0 | 5 |
| 5 | EET | 769.8 | 54 | 0 | 76.2 | 5 |

The experimental system consisted of a 1000 ml type Erlenmeyer flask with a magnetic stirrer. A hot plate used to provide most of the heat input was augmented with a heating lamp connected to a PID controller to control temperature based on a set point. Experiments were initiated by heating ESBO and EG to 125° C.; at which point, p-Toluenesulfonic acid monohydrate (catalyst) was added. A combination of exothermic heat of reaction and heat input was used to bring the mixture to a final temperature of 160° C. or 140° C. It took about 15 minutes for the mixture to reach the set point temperature. The equation 1 was used to empirically quantify the temperature profile as fit to temperature versus time data from the experiment. The equation was then used to calculate the temperature in the Matlab model. For EED and EET polyols, ESBO and EG were heated up for 90 minutes (during which catalyst was added and temperature was kept at 161° C.). Then hot DEG or TEG were added to the mixture according to the recipe.

Epoxy numbers, hydroxyl numbers, and viscosities were used to characterize products and intermediates. Epoxy number of the polyols was determined using oxirane oxygen titration (AOCS Cd 9-57). Hydroxyl numbers were determined using AOCS Ts 1a-66 method. The dynamic viscosities were measured using a Cole-Parmer basic viscometer.

The EE polyol was synthesized at both 140 and 160° C. with the profile and model fit. The model provides a good fit to the data accurately charactering the faster reaction rate constant at 160° C. and the slower initial reaction due to the lower initial temperature. The series of rate expressions and differential equations used to model this system are summarized in Table 2. The Arrhenius parameters of the fitted model are summarized in Table 3.

TABLE 2
Reactions, reaction rates and stoichiometric coefficients for each component.

| Rxn # | Reaction | Rate Expression | dC_{EPOXY}/dt | dC_{ESBO}/dt | dC_{EG}/dt | dC_{DEG}/dt | dC_{TEG}/dt | dC_{P}/dt |
|---|---|---|---|---|---|---|---|---|
| 1 | ESBO + EG→P | r(1) = k(1) f_{ESBO}C_{ESBO}f_{EG}C_{EG} | −1 | −1 | −1 | 0 | 0 | 1 |
| 2 | ESBO + DEG→P | r(2) = k(2) f_{ESBO}C_{ESBO}f_{DEG}C_{DEG} | −1 | −1 | 0 | −1 | 0 | 1 |
| 3 | ESBO + TEG→P | r(3) = k(3) f_{ESBO}C_{ESBO}f_{TEG}C_{TEG} | −1 | −1 | 0 | 0 | −1 | 1 |
| 4 | ESBO + P_{ALCOHOL}→P | r(4) = k(4)f_{ESBO}C_{ESBO}(M_{ALCOHOLp} − | −1 | −1 | 0 | 0 | 0 | 0 |
| | | Σᵢ₌₁³ f_{Alcohol i} * C_{Alcohol i}) | | | | | | |
| 5 | P_{EPOXY} + EG→P | r(5) = k(5) (M_{ESBO} − f_{ESBO}C_{ESBO})f_{EG}C_{EG} | −1 | 0 | −1 | 0 | 0 | 0 |
| 6 | P_{EPOXY} + DEG→P | r(6) = k(6) (M_{ESBO} − f_{ESBO}C_{ESBO})f_{DEG}C_{DEG} | −1 | 0 | 0 | −1 | 0 | 0 |
| 7 | P_{EPOXY} + TEG→P | r(7) = k(7) (M_{ESBO} − f_{ESBO}C_{ESBO})f_{TEG}C_{TEG} | −1 | 0 | 0 | 0 | −1 | 0 |
| 8 | P_{EPOXY} + P_{ALCOHOL}→P | r(8) = k(8)(M_{ESBO} − f_{ESBO}C_{ESBO}) | −1 | 0 | 0 | 0 | 0 | −mDP\hat{ }n |
| | | (M_{ALCOHOLp} − Σᵢ₌₁³ f_{Alcohol i} * C_{Alcohol i}) | | | | | | |
| 9 | P_{EPOXY} →P | r(9) = k(9) * C_{EPOXY} | −1 | 0 | 0 | 0 | 0 | 0 |

The same values of the pre exponential factor and activation energy were able to characterize k(1), k(4), k(5) and k(8). Within the accuracy of the data, the reaction rates between the alcohol and epoxy moieties were the same, independent of whether the moieties were attached to the monomer or polymer.

TABLE 3
Kinetic parameters based on the modeling results for EE polyol.

| Kinetic Parameters | A (J/mol) | E (J/mol) | k (161° C.) | k (140° C.) |
|---|---|---|---|---|
| Epoxy and Alcohol | 5.5E+17 | 1.40E+05 | 35.47 | 5.39 |
| monomer | | | | |

Relative to the ED-forming reaction, the ET-forming reaction was faster. Also, the EE-forming reaction was faster than the ET-forming reaction. The model-lines were generated using the same Arrhenious parameters as provided in Table 3. Within this range of diols, the moieties reacted independent of the monomer and/or polymer to which they were attached. The slower reaction rates observed for the ED and ET oligomers was primarily due to the dilution impact of the (C-C-O)n repeat units of the diol reagents.

The reaction profiles include the addition of DEG and TEG, respectively, after the first 4800 seconds of reaction. This addition resulted in an immediate change in epoxy number due to dilution and a slower subsequent reaction rate due to dilution. Both are properly accounted for by the model. By adding the DEG and TEG at the end of the reaction, more of these longer straight-chain segments will be branches as opposed to cross-links. Longer branches on the oligomer have the potential to reduce viscosity, especially dynamic viscosity.

Capping with DEG and TEG was effective in reducing viscosity. At the same final epoxy number, EE has a greater viscosity than EED which has a greater viscosity than EET. For an epoxy number of 2.6, EE, EED and EET have viscosities of 4800, 2800 and 2200, respectively.

The dilution impact would adjust the epoxy number by about 2.5% of 6.2 (about 0.16 change in epoxy number). The impact of the capping is much greater than can be accounted for by dilution and can be attributed to less entanglement and more alignment of longer branches on the SBO backbone. The oligomers with longer branches should also show, relatively, improved resilience and respective better performance in flexible urethane foam applications.

Primary conclusions are that the model effectively simulates the performance and that the variation in final properties can be extensive. As a fundamentally-based model, the results can be extrapolated (within reason) to determine the sensitivity to various reagent and reaction parameters.

### ILLUSTRATIVE EXAMPLE 2

The reactions of Illustrative Example 1 were simulated with varying values of n in the equation −DP̂n for the stoichiometric coefficient for inter-poiymerization. FIG. 1(a) summarizes the simulation results. Larger values of n led to more rapid onset of the gel point as illustrated by the rapid increase in PDP (PDP is the degree of polymerization of the polymers in the mixture which excludes unreacted monomers in the calculation). FIG. 1(b) illustrates the impact of different constants for the stoichiometric coefficient −[constant]*DP̂n in this model. These constants take into account how the limit of polymerization at zero reaction may vary from 1.0 for reaction systems were the monomers have functionalities greater than 2.0.

This illustrative example provides a good example of how polymer concentrations in the simulation will initially increase to achieve a maximum and then decrease due to crosslinking (inter-polymerization). Polymer concentrations going to zero after achieving a maximum concentration illustrate gelling of the system.

### ILLUSTRATIVE EXAMPLE 3

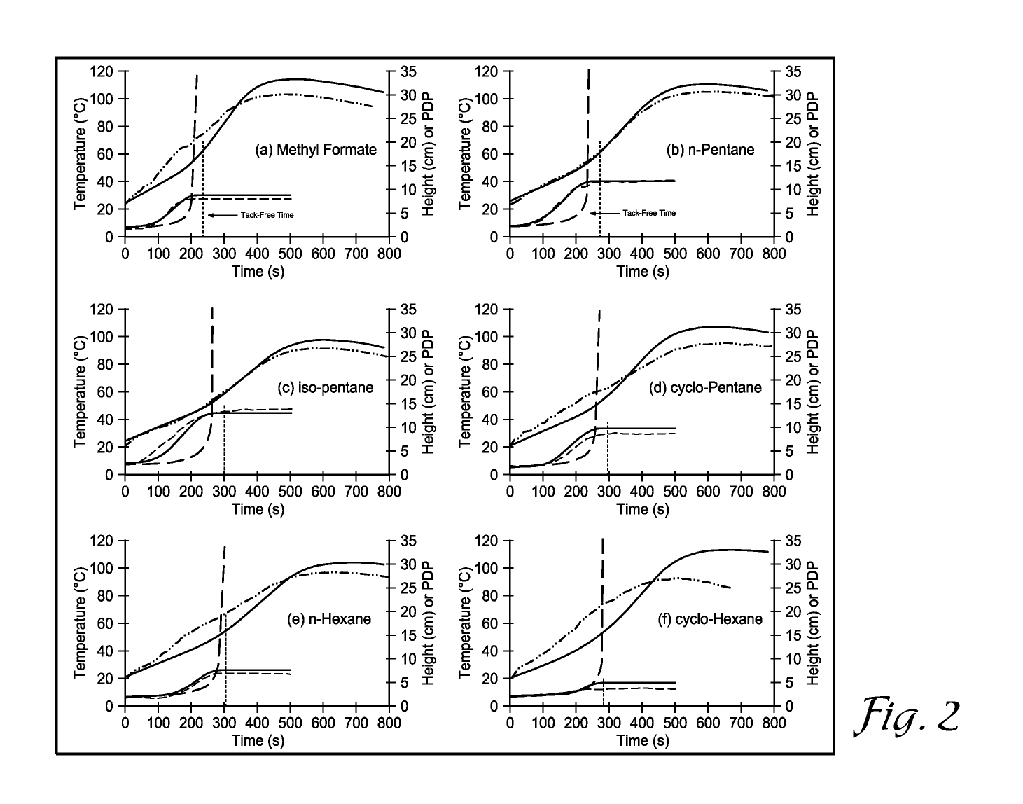

A series of experimental studies and simulations were performed for different blowing agents including methyl formate, n-pentane, isopentane, cyclopentane, n-hexane, and cyclohexane. A comparison of simulation results to experimental data is summarized by FIG. 2. The results illustrate how the simulation successfully accounts for the following phenomena: (a) different impacts on temperature profiles for different blowing agents, (b) variations in tack free times (vertical lines) as estimated by rapid increase in PDP and as considered to occur shortly after the gel point (rapid increase in PDP), and (c) entrapment of blowing agent leading to low heights once the gel point is reached.

It is to be understood that while certain now preferred forms of this invention have been illustrated and described, it is not limited thereto except insofar as such limitations are included in the following claims.

Having thus described the invention, what is claimed as new and desired to be secured by Letters Patent is as follows:

1. A method for simulating a polymerization reaction comprised of
estimating reactive moiety concentration, degree of polymerization, and temperature as a function of time;
solution of multiple differential equations describing changes in composition that occur as a result of reaction;
use of data on monomers including the number of reactive moieties on the monomers, the concentration of reaction moieties of the monomers, reaction rate parameters sufficient to calculate reaction rate constants, heats of reaction, and heat capacities;
use of data characterizing the impact of catalysts on reactivity as a function of temperature, catalyst, and type of reaction; and
solution of at least one differential equation on the reaction of a polymer molecule with itself in a self-reaction resulting in no change in polymer concentration, at least one differential equation on the reaction of a polymer molecule with another polymer molecule resulting in a decrease in polymer concentration, and use of a calculation algorithm with a limit of reaction such that as polymer concentration (e.g., moles/liter) goes to zero due to self-reaction after reaching a peak polymer concentration there is 100% polymer self-reaction.

2. The method of claim 1 where the algorithm includes the calculation of average degree of polymerization and use of the average degree of polymerization to estimate the rate of self-reaction.

3. The method of claim 1 comprised of a chain growth reaction algorithm that includes the concentration of a complex of a catalyst with a reactive moiety in at least one reaction rate expression.

4. The method of claim 3 comprised of at least one rate expression for the formation of the complex, at least one rate expression for the disassociation of the complex, and an algorithm that estimates the initial concentration of the complex as an initial condition.

5. The method of claim 1 comprised of at least one differential equation for estimating the rate of mass transfer of first moiety to a second moiety where the first moiety and second moiety react to form a polymer bond where the differential equation is first order in the concentration of one of the moieties, where the equation includes a moiety mass transfer factor multiplied times a concentration driving force for the rate, and where the moiety mass transfer factor is estimated by an algorithm where the algorithm estimates the moiety mass transfer factor to increase with increasing temperature when other properties are held constant and to decrease with increasing average degree of polymerization when other properties are held constant.

6. The method of claim 5 where the rate of mass transfer approaches zero as the concentration of polymer approaches zero after the polymer concentration has reached a maximum value.

7. The method of claim 1 including a first algorithm for estimating of vapor phase emissions in the air surrounding the foam where the algorithm is comprised of estimating the partial pressures of chemical components of the resin phase where the vapor pressures of components increase with increasing pure component vapor pressures.

8. The method of claim 7 including a second algorithm for estimating the fraction of open cell content in the foam and the fraction of closed cell content where the sum of two fractions is 1.0 and where the first algorithm includes the use of a mass transfer factor and where a third algorithm estimates the mass transfer factor where increasing open cell content causes the mass transfer factor to have a tendency to increase where the second algorithm includes the calculation of viscosity and the amount of blowing agent that has evaporated to determine the fraction of cells that rupture leading to open cell formation.

9. The method of claim 1 where the differential equations include an energy accumulation rate equation as derived from an energy balance which includes: heat effects associated with generation of blowing agent gas, estimation of final volume of gas cells in the resin, and estimation of at least one physical property of the foam as the addition of the gas phase contribution to the physical property plus the resin phase contribution to the physical property.

10. The method of claim 1 as a method to characterize the functionality of a monomer where,
the simulation results are compared to experimental gel reaction data on viscosity versus time and temperature versus time
at least one property of at least one monomer is a fitted parameter in the simulation that is varied to obtain a best fit of simulation results to experimental data and
the monomer property is the functionality of a polyol that is obtained by comparing data to simulation results on viscosity as viscosity increases to values greater than 20,000 cP.

11. The method of claim 1 where the differential equations include an energy accumulation rate equation as derived from an energy balance which includes: heat effects associated with generation of blowing agent gas, estimation of final volume of gas cells in the resin, estimation of viscosity of the resin phase, and an algorithm to determine whether the fraction of blowing agent that successfully forms cells of the foam.

12. A method for simulating the evaporation of one or more blowing agents during the simulation of an exothermic polymer-forming reaction comprised of estimating the rate of evaporation as a blowing agent mass transfer factor times a driving force for evaporation.

13. The method of claim 12 where the driving force for evaporation is the difference between a quantity based on at least one gas phase simulated property and a quantity based on at least one liquid phase simulated property where the liquid phase property is related to the concentration of blowing agent in the liquid phase and the gas phase property is related to the concentration of the blowing agent in the gas phase.

14. The method of claim 12 where the rate of change of blowing agent in the liquid phase is used in an energy balance equation to estimate changes in temperature during the simulation.

15. The method of 12 including a calculation algorithm to estimate the blowing agent mass transfer factor where the blowing agent mass transfer factor has a limit of performance such that as polymer concentration goes to zero due to self-reaction the factor is less than 0.2 times the value of the factor at peak polymer concentration.

16. A three-dimensional printing method comprised of an application method where an A-side monomer mixes with a B-side monomer to form a three-dimensional thermoset polymer product comprised of:
at least two resin mixtures where a first resin mixture generates a gas as a result of mixing with a second resin mixture, and
a computer-based calculation method to provide mixing ratios of the resin mixtures to achieve a desired foam density.

17. The method of claim 16 where the resin mixtures are in the form of resin wires where at least one of the wires is a thermoplastic resin wire comprised of a mixture of thermoplastic resin mixed with a monomer where the monomer has a functionality greater than 2.0.

18. The method of claim 16 where the computer-based calculation method controls the printer to print at a higher surface rate of coverage when applying foams of lower density.

19. The method of claim 16 comprised of the following steps of printing of a wall having a final density is greater than 0.5 g/ml and printing of a foam next to the wall having a final density less than 0.5 g/ml.

20. The method of claim 19 where the surface of the foam is scanned and printing is performed to fill in crevices of the surface.

21. The method of claim 16 where a first printer tip applies a mixture containing the A-side monomer and a second printer tip applies a B-side monomer where the first and second printer tips apply different monomers within 0.3 mm distance of separation.

22. The method of method of claim 16 where the resin mixtures are applied by a mobile applicator able to traverse an independent surface of greater than one square meter.

23. The method of method of claim 16 where the resins are printed on a surface and the surface is a series of circumference surfaces on a rotating lathe.
